(19) United States
(12) Patent Application Publication
(10) Pub. No.: US 2013/0077297 A1
(43) Pub. Date: Mar. 28, 2013

(54) LED FLUORESCENT TUBE STRUCTURE

(71) Applicants: CHIH-HSIEN WU, NEW TAIPEI CITY (TW); PO-WEN HSIAO, NEW TAIPEI CITY (TW)

(72) Inventors: CHIH-HSIEN WU, NEW TAIPEI CITY (TW); PO-WEN HSIAO, NEW TAIPEI CITY (TW)

(73) Assignee: UNITY OPTO TECHNOLOGY CO., LTD., NEW TAIPEI CITY (TW)

(21) Appl. No.: 13/291,276

(22) Filed: Nov. 8, 2011

(30) Foreign Application Priority Data
Sep. 27, 2011 (TW) 100218060

(51) Int. Cl. F21V 29/00

(52) U.S. Cl. 362/218

(57) ABSTRACT

An LED fluorescent tube structure includes a transparent cover, a cooling block, at least one LED lamp panel and a pair of side covers. The transparent cover includes a heat dissipating opening having a pair of first hooks, and an embedding slot. The top of the cooling block is provided for carrying the LED lamp panel and embedded into the transparent cover. A latch groove at the bottom of the cooling block has a tapered opening for latching the transparent cover. The side covers are sealed onto both end portions of the transparent cover respectively. The latch groove is designed with an angle for enhancing a latching effect to assure the spatial distance of the heat dissipating opening. The latch groove at a position connecting the cooling block is thickened to enhance the strength of the cooling block, prevent deformations, and improve the aesthetic look and using effect.

### BACKGROUND OF THE INVENTION

1. Field of the Invention

The present invention relates to the field of illumination devices, in particular to an LED fluorescent tube structure that complies with the illumination safety regulations of different countries and provides a good heat dissipation effect.

2. Description of the Related Art

With the advantages of power saving, high brightness, long service life and mercury pollution-free feature, light emitting diodes (LED) are applied extensively for manufacturing illumination lamps including LED fluorescent tubes and LED bulbs. The LED fluorescent tube and LED bulbs have gradually replaced traditional fluorescent lamps and bulbs and meet the power saving and carbon reduction requirements.

For example, the LED fluorescent tube generally comprises a lamp cover, a lamp base and at least one LED lamp panel, wherein the LED lamp panel includes a plurality of LEDs installed thereon; the LED lamp panel is mounted onto the lamp base; and the lamp cover and the lamp base are a semicircular arc structure and coupled to form a circular tabular structure. To fix the LED lamp panel, a plurality of screw holes with threads are formed on the lamp base, and a plurality of fixing screws are used for mounting the LED lamp panel. Since it is necessary to secure the screws one by one in an assembling process, the manufacture takes much time and manpower and uses a large quantity of screws that incur a higher manufacturing cost. Furthermore, the securing force cannot be controlled easily or evenly. As a result, the LED lamp panel may be warped or deformed.

A large quantity of heat will be produced during the use of the LED lamp panel, and thus the lamp base is generally made of aluminum with a good thermal conductivity by the aluminum extrusion method, and the heat generated from the use of the LED fluorescent tube can be conducted and dissipated. In general, an LED fluorescent tube usually has a lamp base which is not installed tightly, and there is a potential risk of touching the lamp base and getting an electric shock by accident when a user changes the fluorescent tube. Therefore, different countries have strict safety laws and regulations for the LED fluorescent tubes.

In view of the aforementioned problems, the inventor of the present invention has designed an improved lamp structure as disclosed in R.O.C. Pat. No. M389827 which is an LED fluorescent tube comprising a cover made of a non-conductive material for covering a heat dissipating device and a substrate made by an aluminum extrusion method to prevent users from touching the cover accidentally or being injured by an electric shock. The cover includes a heat dissipating opening formed at the periphery of the cover and provided for passing a gas to dissipate the heat generated by a plurality of LEDs on the substrate and achieve the effects of improving the service life of the LEDs and reducing the damage to the lamp. It is noteworthy to point out that the heat dissipating opening comes with a size in compliance with the safety requirements and meets the requirements set forth by regulations including UL 1993 & IEC62031, IEC61347-1 and IEC60529. However, the heat dissipating opening comes with a design of being expanded outwardly and has two side arms installed at the tapered opening formed at the bottom of the heat dissipating device for latching the heat dissipating opening, such that the heat dissipating opening can maintain it width within a predetermined range. However, if a long lamp tube is used, the thickness of the side arms is insufficient to provide the required strength and the included angle between the side arms and the heat dissipating device is smaller than 90 degrees. Thus it is difficult to support the heat dissipating device effectively, and both end portions and the central portion of the heat dissipating device may be deformed or bent easily to cause a partially closed heat dissipating opening or affect the aesthetic look and the heat dissipating effect adversely, and such lamp structure definitely requires improvements.

In view of the foregoing problems, the inventor of the present invention disclosed a novel cooling block structure comprising a latch groove formed at the bottom of the cooling block structure and extended vertically downward and having a tapered opening for latching a cover, and the latch groove is thickened to improve the overall strength, so that when this design is applied to a long lamp tube, the cooling block structure will not be bent or deformed easily, or the heat dissipating opening will not be partially closed. Obviously, the present invention can provide a better effect.

### SUMMARY OF THE INVENTION

Therefore, it is a primary objective of the present invention to provide an LED fluorescent tube structure that makes use of the shape of an opening of a latch groove of a cooling block for latching a transparent cover, so as to avoid the assembled structure from being loosened and assure a sufficient spatial distance of a heat dissipating opening of the transparent cover.

Another objective of the present invention is to provide an LED fluorescent tube structure that thickens the portion of the cooling block connected to the latch groove to improve the overall strength of the assembled structure to prevent it from being bent or deformed easily.

To achieve the foregoing objective, the present invention provides an LED fluorescent tube structure, comprising: a transparent cover, being a circular tabular structure made of an elastic transparent material, and having a heat dissipating opening axially formed on the transparent cover, and a pair of first hooks extended from the heat dissipating opening towards the interior of the transparent cover, and a pair of protruding ribs formed on an inner wall of the transparent cover to form an embedding slot; a cooling block, inserted into the embedding slot, a latch groove formed vertically downward from the bottom of the cooling block and having a tapered opening for propping and supporting the pair of first hooks of the transparent cover;

at least one LED lamp panel, mounted to the top of the cooling block, and the LED lamp panel having a plurality of LEDs; and
a pair of side covers, made of an insulating material, and sheathed on both end portions of the transparent cover respectively, and the side cover including a pair of electrical connection portions and a partition disposed therein, and the electrical connection portion being electrically coupled to the LED lamp panel, and the partition being installed within the heat dissipating opening.

Wherein, the heat dissipating opening is an opening having a spatial distance smaller than 2 mm.

Wherein, a surface distance greater than 5 mm is maintained from the bottom of the cooling block to an external rim of the heat dissipating opening.

In a preferred embodiment, the cooling block includes an extension section disposed separately on both sides of the cooling block and inside the embedding slot, a guide slot formed on a side of the top of the cooling block, and a fixing slot formed on another side of the guide slot, wherein a lateral edge of the LED lamp panel is latched into the guide slot, and another lateral edge of the LED lamp panel has a plurality of positioning holes for securing the LED lamp panel to the fixing slot. In addition, a C-shape slot is formed at the latch groove and disposed at a position opposite to the other side of the fixing slot for securing the side covers, and each of the side covers has a fixing hole corresponding to the C-shape slot for screwing and securing an insulating screw. In addition, the insulating screw has a nut portion made of an insulating material. After the LED fluorescent tube structure of the present invention is assembled, the side covers are electrically insulated to prevent a possible electric shock.

In a preferred embodiment, the LED fluorescent tube structure of the present invention further comprises a pair of second hooks installed at both end portions of the latch groove respectively for propping and supporting the pair of first hooks to latch the transparent cover.

In addition, the partition includes a reinforcing plate installed at the top of the partition, and the reinforcing plate is provided for propping and supporting the pair of first hooks to enhance the stability of the assembled structure.

In addition, the interior of each of the side covers includes a bump for connecting the heat dissipating opening tightly to seal the heat dissipating opening, so as to prevent bugs from entering from the heat dissipating opening,

### BRIEF DESCRIPTION OF THE DRAWINGS

FIG. 1 is an exploded view of a preferred embodiment of the present invention;

FIG. 2 is a perspective view of a preferred embodiment of the present invention;

FIG. 3 is a cross-sectional view of an assembly of a preferred embodiment of the present invention; and

FIG. 4 is another cross-sectional view of an assembly of a preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

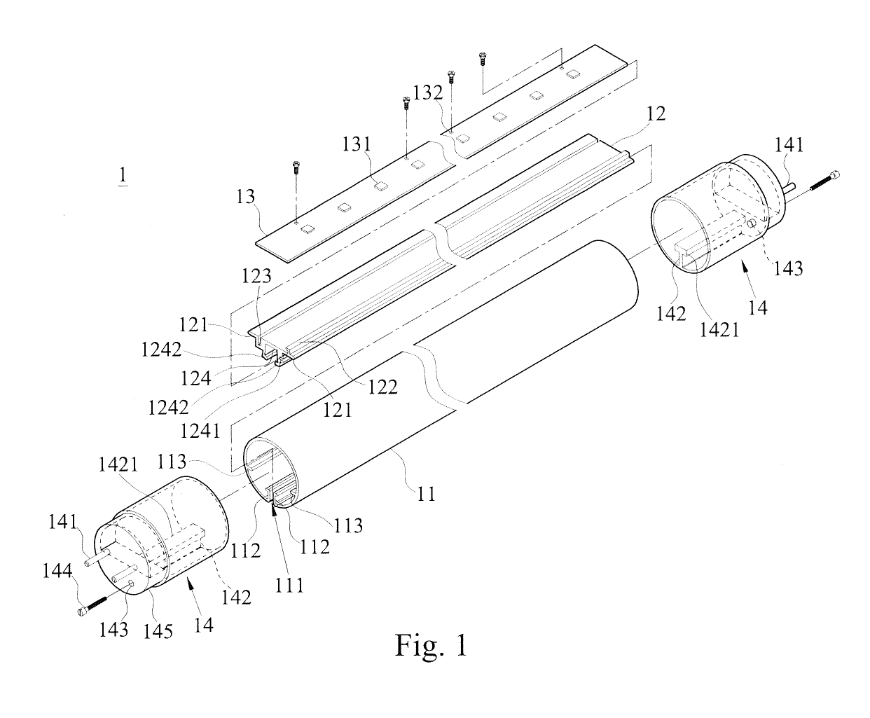

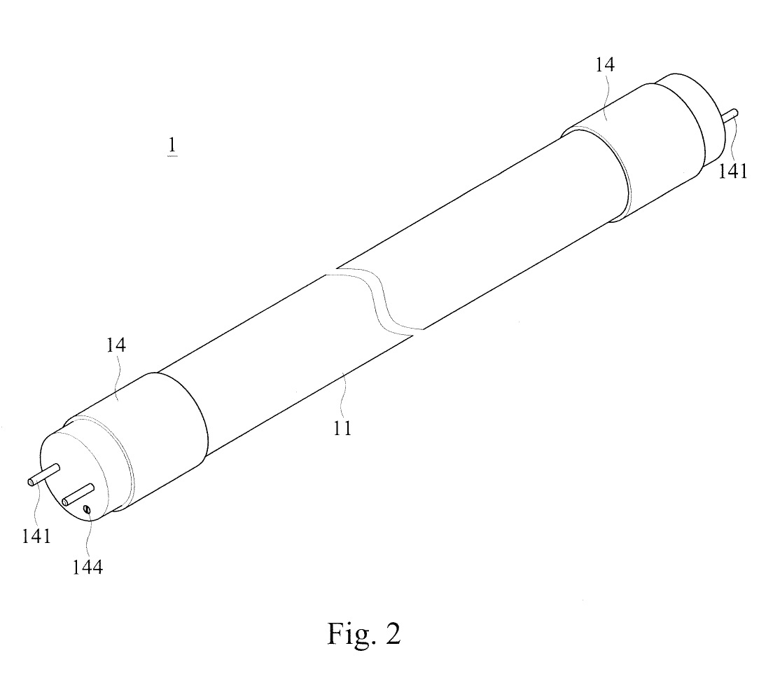

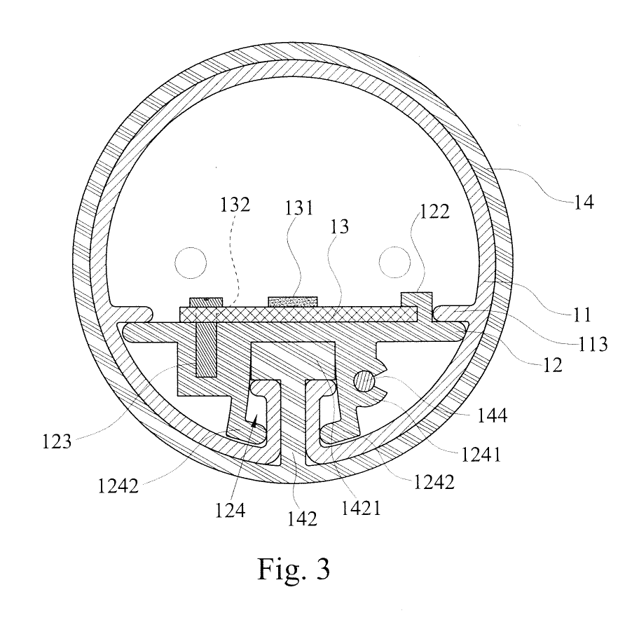

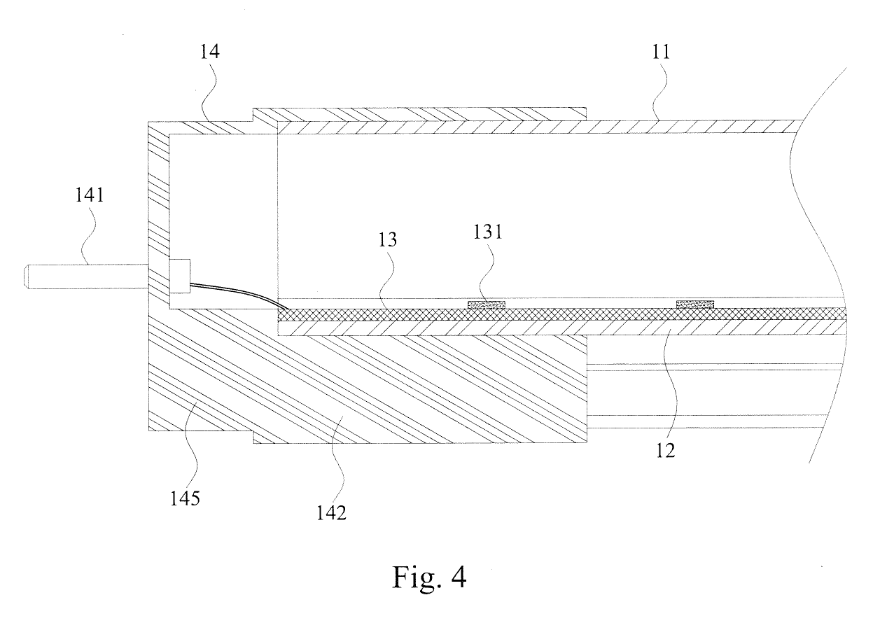

With reference to FIGS. 1 to 4 for an exploded view, a perspective view and cross-sectional views of an LED fluorescent tube structure in accordance with a preferred embodiment of the present invention respectively, the LED fluorescent tube structure 1 comprises a transparent cover 11, a cooling block 12, an LED lamp panel 13 and a pair of side covers 14.

Wherein, the transparent cover 11 is a circular tabular structure made of an elastic transparent material (such as a plastic material) which is an electrically insulator capable of avoiding electric shocks, and a heat dissipating opening 111 is formed axially along the transparent cover 11, and the heat dissipating opening 111 includes a pair of first hooks 112 inwardly extended towards the transparent cover 11. Since the transparent cover 11 is made of an elastic transparent material, the pair of first hooks 112 are normally maintained at a position of being propped outwardly, and the transparent cover 11 includes a pair of protruding ribs 113 on an inner wall of the transparent cover 11 to form an embedding slot (not shown in the figure) for installing the cooling block 12 and the LED lamp panel 13. It is noteworthy to point out that the heat dissipating opening 111 is an opening having a spatial distance smaller than 2 mm, which complies with the regulations as set forth in related safety laws and assure the gaseous circulation.

The cooling block 12 is a long striped structure made by aluminum through an aluminum extrusion method, and the cooling block 12 includes an extension section 121 formed separately in the embedding slot, and the cooling block 12 has a guide slot 122 formed at the top of the cooling block 12, a fixing slot 123 formed at a position opposite to another side of the guide slot 122, and a latch groove 124 formed vertically downward at the bottom of the cooling block 12 and having a tapered opening. When the cooling block 12 is assembled to the transparent cover H, the pair of first hooks 112 of the transparent cover 11 are provided and propped in the latch groove 124. In addition, a C-shape slot 1241 is formed on the latch groove 124 and at a position opposite to another side of the fixing slot 123 and provided for the securing purpose. To further enhance the stability of the assembled structure, a second hook 1242 is installed at both end portions of the latch groove 124 separately for propping the pair of first hooks 112 to achieve a secured latching effect and prevent loosened parts. It is noteworthy to point out that a surface distance greater than 5 mm is maintained from the bottom of the cooling block 12 to the external rim of the heat dissipating opening 111 to meet the safety requirements.

The LED lamp panel 13 includes a plurality of LEDs 131, and a side of the LED lamp panel 13 is latched into the guide slot 122 at the top of the cooling block 12, and another side of the LED lamp panel 13 has a plurality of positioning holes 132 and screwed and secured into the fixing slot 123.

The pair of side covers 14 are made of an insulating material and respectively sheathed on both end portions of the transparent cover 11, wherein the side covers 14 contain a pair of electrical connection portions 141 and a partition 142, and the electrical connection portion 141 is electrically coupled to the LED lamp panel 13, and the partition 142 is installed within the heat dissipating opening 111 for the positioning purpose. In addition, each of the side covers 14 has a fixing hole 143 formed at a position corresponding to the C-shape slot 1241 for installing and securing an insulating screw 144, and a nut portion of the insulating screw 144 is made of an insulating material, so that after the side covers 14 are secured to both end portions of the transparent cover 11 or the side covers 14 are fixed directly to both end portions of the transparent cover 11 by an adhesive, a complete insulation effect can be achieved to prevent a possible electric shock that may occur when a user changes the fluorescent tube. In addition, a reinforcing plate 1421 is installed at the top of the partition 142 and provided for propping and supporting the pair of first hooks 112. In addition, a bump 145 is formed inside each of the side covers 14 and disposed at a position wherein the partition 142 is coupled to the side cover 14, so that the heat dissipating opening 111 of the assembled structure can be coupled and sealed tightly to prevent bugs from entering into the fluorescent tube or damaging the lamp.

While the invention has been described by means of specific embodiments, numerous modifications and variations could be made thereto by those skilled in the art without departing from the scope and spirit of the invention set forth in the claims.

What is claimed is:

1. An LED fluorescent tube structure, comprising:
a transparent cover, being a circular tabular structure made of an elastic transparent material, and having a heat dissipating opening axially formed on the transparent cover, and a pair of first hooks extended from the heat dissipating opening towards the interior of the transparent cover, and a pair of protruding ribs formed on an inner wall of the transparent cover to form an embedding slot;
a cooling block, inserted into the embedding slot, a latch groove formed vertically downward from the bottom of the cooling block and having a tapered opening for propping and supporting the pair of first hooks of the transparent cover;
at least one LED lamp panel, mounted to the top of the cooling block, and the LED lamp panel having a plurality of LEDs; and
a pair of side covers, made of an insulating material, and sheathed on both end portions of the transparent cover respectively, and the side cover including a pair of electrical connection portions and a partition disposed therein, and the electrical connection portion being electrically coupled to the LED lamp panel, and the partition being installed within the heat dissipating opening.

2. The LED fluorescent tube structure of claim 1, wherein the cooling block includes an extension section disposed separately on both sides of the cooling block and inside the embedding slot, a guide slot formed on a side of the top of the cooling block, a fixing slot formed on another side of the guide slot, and a lateral edge of the LED lamp panel is latched into the guide slot, and another lateral edge of the LED lamp panel has a plurality of positioning holes for screwing and securing the LED lamp panel to the fixing slot.

3. The LED fluorescent tube structure of claim 2, further comprising a C-shape slot formed at the latch groove and disposed at a position opposite to the other side of the fixing slot.

4. The LED fluorescent tube structure of claim 3, wherein each of the side covers has a fixing hole corresponding to the C-shape slot for securing an insulating screw.

5. The LED fluorescent tube structure of claim 4, wherein, the insulating screw has a nut portion made of an insulating material.

6. The LED fluorescent tube structure of claim 1, further comprising a pair of second hooks installed at both end portions of the latch groove respectively for propping and supporting the pair of first hooks.

7. The LED fluorescent tube structure of claim 1, wherein the heat dissipating opening is an opening having a spatial distance smaller than 2 mm.

8. The LED fluorescent tube structure of claim 1, wherein the distance from the bottom of the cooling block to an external rim of the heat dissipating opening is defined as a surface distance , and the surface distance is greater than 5 mm.

9. The LED fluorescent tube structure of claim 1, wherein the partition includes a reinforcing plate installed at the top of the partition. and the reinforcing plate is provided for propping and supporting the pair of first hooks.

10. The LED fluorescent tube structure of claim 1, wherein a bump is formed in the interior of the side covers respectively for connecting the heat dissipating opening tightly to seal the heat dissipating opening.
